(19) United States
(12) Patent Application Publication
(10) Pub. No.: US 2021/0382989 A1
(43) Pub. Date: Dec. 9, 2021

(54) MULTILEVEL CONSISTENCY CHECK FOR A CYBER ATTACK DETECTION IN AN AUTOMATION AND CONTROL SYSTEM

(71) Applicant: SIEMENS AKTIENGESELLSCHAFT, MÜNCHEN (DE)

(72) Inventors: Dong Wei, Edison, NJ (US); Leandro Pfleger de Aguiar, Robbinsville, NJ (US); Stefan Woronka, Baddeckenstedt (DE)

(21) Appl. No.: 17/284,539

(22) PCT Filed: Nov. 8, 2019
(86) PCT No.: PCT/US2019/060423

§ 371 Date: Apr. 12, 2021

Related U.S. Application Data
(60) Provisional application No. 62/769,594, filed on Nov. 20, 2018.

(51) Int. Cl. G06F 21/55; G05B 19/042; G05B 19/418; G05B 23/02

(52) U.S. Cl. CPC G06F 21/552; G06F 21/554; G05B 23/0235; G05B 19/418; G05B 19/0428

(57) ABSTRACT

A system and a method provide multilevel consistency check for a cyber attack detection in an automation and control system wherein the multilevel consistency check of sensor measurements, commands and settings on different automation devices on a plant floor is able to provide end-to-end intrusion detection on exchanged data. The multilevel consistency check includes a measurement consistency check and a commands and settings consistency check to enable a cyber security solution for industrial control systems (ICS). An alarm is set when detecting a first value inconsistent from a second value. An anomaly is detected based on at least one of the measurement consistency or the commands and settings consistency and it is identified as an intrusion detection.

### CROSS REFERENCE TO RELATED APPLICATIONS

This application claims the benefit of U.S. Provisional Application Ser. No. 62/769,594 entitled “DISTRIBUTED ICS ANOMALY DETECTION METHOD BY USING INTELLIGENT PLANT FLOOR NETWORK SENSORS,” filed on Nov. 20, 2018, the contents of which are hereby incorporated by reference herein in their entirety.

### BACKGROUND

### 1. Field

Aspects of the present invention generally relate to a system and a method that enable multilevel consistency check for a cyber attack detection in an automation and control system wherein the multilevel consistency check of sensor measurements, commands and settings on different automation devices on a plant floor is able to provide end-to-end intrusion detection on exchanged data.

### 2. Description of the Related Art

Cyber attacks on private computer networks have long been at the forefront of detection and protection efforts using information technology. Now the threat of cyber attacker intrusion to industrial systems, such as automation and control systems that support critical infrastructure, is gaining attention. Due to aspects like vertical integration of the production systems and horizontal integration of the value chain, industrial control system (ICS) networks are often directly or indirectly connected to IT networks (office network) and the Internet, hence offering an opportunity for cyber attackers to penetrate such environments and exploit any existing vulnerabilities. OT (Operations Technology) systems such as programmable logic controllers (PLCs), Distributed Control Systems (DCS), motion controllers, Supervisory Control and Data Acquisition (SCADA) servers, and Human Machine Interfaces (HMIs) offer many additional challenges when it comes to deploying security measures.

Attack methods have evolved over recent years from simple methods performed by curious hackers to advanced persistent threats (APTs) carefully designed by highly motivated top experts, sometimes with extended resources sponsored by nation states. Detecting such targeted attacks and other general attack campaigns require the development of additional detection methods and coverage. Such sophisticated cyber-attacks aimed at OT devices are often intentionally camouflaged under normal network traffic and hidden inside legitimate systems with methods that avoid detection by existing signature based malware detection methods.

Cyber security for industrial control systems (ICS) is an emerging topic that has continuously drawn attention of the entire community over the past few years. In particular, the ability to detect advanced ICS focused attacks remains a challenge, giving the complexity, scale, and heterogeneity of such systems. Not much research has been performed, for example, on level 0 devices (ref. to PURDUE/ISA S95 model), such as sensors, actuators and drives. One question can be naturally raised—can sensor, actuators and drives and their supporting networks get compromised by malicious actors?

The answer to this question is yes because sensors, actuator and drives are networked, either directly to the plant floor network or via fieldbus to control systems. Most sensors, actuators and drives are connected to the control system via fieldbus, such as Profibus, Profinet or Modbus, for process control purposes. Some of them are also connected to the plant floor network via Ethernet for monitoring and diagnostics use. Therefore, they are exposed to potential hackers. However, these devices are designed without consideration of cyber attacks. Furthermore, due to limited resources in terms of computational power and memory space, these devices are not able to run cybersecurity functions. For example, intrusion detection is usually not able to run at level 0.

The current cyber security solutions for industrial control systems (ICS) were developed based on the assumption that network segmentation is utilized as a premise to ensure attackers will never get access to level 0 and level 1 devices, directly. For example, an architecture may be configured with five production cells on a plant floor level. The network of each production cell is isolated from others and protected by a security device, e.g. firewall/VPN (Virtual Private Network) concentrator. This security solution was developed based on the assumption that cyber attacks come from the outside world, i.e. the communication link between the production cell network and the office network. However, past and recent examples of sophisticated malware to control systems such as SandWorm, and DragonFly have demonstrated the damage potential that simplistic assumptions might lead to. This “segmentation” solution may not work anymore for the following reasons:
a. Actuators, sensors and drives provide network interfaces for remote configuration and tuning.
b. Drives and other sensors possess web servers which provide information of product and machine status as predictive maintenance information for operation and maintenance professionals.
c. IoT-based manufacturing systems require control systems to exchange data with business and external production management systems. For instance, more and more mobile devices are enabled to connect to the plant floor network and collect data from level 0 and level 1 devices. Hence, pure network isolation as a sole security measure is no longer acceptable.

Therefore, there is a need of better cyber security solutions for industrial control systems (ICS).

### SUMMARY

Briefly described, aspects of the present invention relate to a system and a method that enable multilevel consistency check for a cyber attack detection in an automation and control system. An intelligent plant floor network sensor (IPFNS) is configured to detect potential cyber attacks on a plant floor network. The intelligent plant floor network sensor (IPFNS) connects to all plant floor automation devices via Ethernet, a wireless communication link or a fieldbus. An automation and control system to monitor data of a sensor, an actuator and drives at different places and ensure those data are consistent in level 0 devices, and level 1 devices, such as a programmable logic controller (PLC), a distributed control system (DCS), a human machine interface (HMI), a network device (switch/router) and a log server. Such a system must guarantee that—1. measurements from sensors (e.g., I/Os) and drives should be consistent in sensors, PLCs, HMI and the log server and 2. command and settings should be consistent in a manufacturing execution system (MES), HMIs, PLCs, log servers and actuators (e.g., I/Os) and drives. Data may be collected from multiple software agents placed at different levels of a control network, which may autonomously activate and execute data collection. Each of the control levels may communicate according to an industrial Ethernet protocol, controlled by routers or Ethernet switches at each level. For example, a switch may be placed within the control network to control data packet routing between control levels. This proposed method can detect fault data injection, especially faked commands/settings and measurements, on the fieldbus and the plant floor Ethernet. The intelligent plant floor network sensor (IPFNS) could be built based on a low cost barebone or industrial computer such as Beaglebone Black board or Raspberry pi board.

In accordance with one illustrative embodiment of the present invention, a computer-based method for multilevel consistency check is provided for a cyber attack detection in an automation and control system. The method comprises placing at least two intelligent network sensors in the automation and control system at different control levels of the system wherein the control levels comprise a first control level and a second control level. The method further comprises checking measurement consistency in an Intrusion Detection System (IDS) Application (APP) by comparing a first measurement value associated with a field device of the automation and control system at a first automation device of the first control level with a second measurement value associated with the field device of the automation and control system at a second automation device of the second control level. The method further comprises setting a first alarm when detecting the first measurement value is inconsistent from the second measurement value. The method further comprises checking commands and settings consistency in the Intrusion Detection System (IDS) Application (APP) by comparing a first commands and settings value associated with the field device of the automation and control system at the first automation device of the first control level with a second commands and settings value associated with the field device of the automation and control system at the second automation device of the second control level. The method further comprises setting a second alarm when detecting the first commands and settings value is inconsistent from the second commands and settings value. The method further comprises detecting an anomaly based on at least one of the measurement consistency or the commands and settings consistency. The method further comprises identifying the anomaly as an intrusion detection.

In accordance with another illustrative embodiment of the present invention, a system is provided for anomaly detection in an automation and control system. The system comprises a plurality of intelligent network sensors, wherein at least two of the intelligent network sensors are placed at different control levels of the automation and control system. The control levels comprise a first control level and a second control level. Each intelligent network sensor comprises an agent configured to collect control data associated with a field device of the automation and control system. Each intelligent network sensor to: read measurements from I/Os and status words from Drives directly via a fieldbus, read process image inputs (PII) directly from a programmable logic controller (PLC) via Ethernet, process measurements values from different automation devices, read commands and settings displayed on HMIs, exchanged via an Industrial Router, a MES and a Log Server via Ethernet or WiFi, read process image outputs (PIQ) directly from a programmable logic controller (PLC) via the Ethernet, and process commands and settings values from different automation devices. The system further comprises an Intrusion Detection System (IDS) Application (APP) hosted in a cloud and configured to: compare a first measurement value associated with a field device of the automation and control system at a first automation device of the first control level with a second measurement value associated with the field device of the automation and control system at a second automation device of the second control level, set a first alarm when detecting the first measurement value is inconsistent from the second measurement value, compare a first commands and settings value associated with the field device of the automation and control system at the first automation device of the first control level with a second commands and settings value associated with the field device of the automation and control system at the second automation device of the second control level, set a second alarm when detecting the first commands and settings value is inconsistent from the second commands and settings value, check measurement consistency and check commands and settings consistency, detect an anomaly based on at least one of the measurement consistency or the commands and settings consistency and identify the anomaly as an intrusion detection.

### BRIEF DESCRIPTION OF THE DRAWINGS

FIG. 1 illustrates a block diagram of an automation and control system that provides a multilevel consistency check-based cyber security solution for industrial control systems (ICS) in accordance with an exemplary embodiment of the present invention.

FIG. 2 illustrates a block diagram of a multilevel intrusion detection system to detect potential cyber attacks on a plant floor network in accordance with an exemplary embodiment of the present invention.

FIG. 3 illustrates a Programmable Logic Controller (PLC) with an intrusion detection agent in accordance with an exemplary embodiment of the present invention.

FIG. 4 illustrates an automation and control system in which an Intelligent Plant Floor Network Sensor (IPFNS) connects to all plant floor automation devices in accordance with an exemplary embodiment of the present invention.

FIG. 5 illustrates temperature sensor measurement readings on different devices in accordance with an exemplary embodiment of the present invention.

FIG. 6 illustrates a sliding window of a photo sensor's readings in accordance with an exemplary embodiment of the present invention.

FIG. 7 illustrates speed setting readings on different devices in accordance with an exemplary embodiment of the present invention.

FIG. 8 illustrates an Intelligent Plant Floor Network Sensor (IPFNS) in accordance with an exemplary embodiment of the present invention.

FIG. 9 illustrates a schematic view of a flow chart of a method of anomaly detection in an automation and control system in accordance with an exemplary embodiment of the present invention.

FIG. 10 shows an example of a computing environment within which embodiments of the disclosure may be implemented.

### DETAILED DESCRIPTION

To facilitate an understanding of embodiments, principles, and features of the present invention, they are explained hereinafter with reference to implementation in illustrative embodiments. In particular, they are described in the context of a system and a method that enable multilevel consistency check for a cyber attack detection in an automation and control system wherein the multilevel consistency check of sensor measurements, commands and settings on different automation devices on a plant floor is able to provide end-to-end intrusion detection on exchanged data. An automation and control system provides a multilevel consistency check-based cyber security solution for industrial control systems (ICS). A multilevel intrusion detection system to detect potential cyber attacks on a plant floor network is provided. A Programmable Logic Controller (PLC) includes an intrusion detection agent. An Intelligent Plant Floor Network Sensor (IPFNS) connects to all plant floor automation devices to enable a method of anomaly detection in an automation and control system. Unlike traditional host-based and network-based intrusion detection technologies, the proposed solution of consistency check of sensor measurements, commands and settings on different automation devices on the plant floor is able to provide end-to-end intrusion detection on exchanged data, which is a new dimension of security. It is able to add security features at plant floor level, especially on level 0 and level 1 devices, which have been ignored so far. End-to-end data consistency check-based intrusion detection is provided at a plant floor level, especially at control level 0 and level 1. The end-to-end data consistency check entails the steps of: 1) collect data of sensor measurements, commands and settings on different devices; 2) process data with production process domain knowledge; 3) compare processed data and report alarm when inconsistency is detected; 4) local intrusion detection and remote (in the cloud) forensic analysis. Embodiments of the present invention, however, are not limited to use in the described devices or methods.

The components and materials described hereinafter as making up the various embodiments are intended to be illustrative and not restrictive. Many suitable components and materials that would perform the same or a similar function as the materials described herein are intended to be embraced within the scope of embodiments of the present invention.

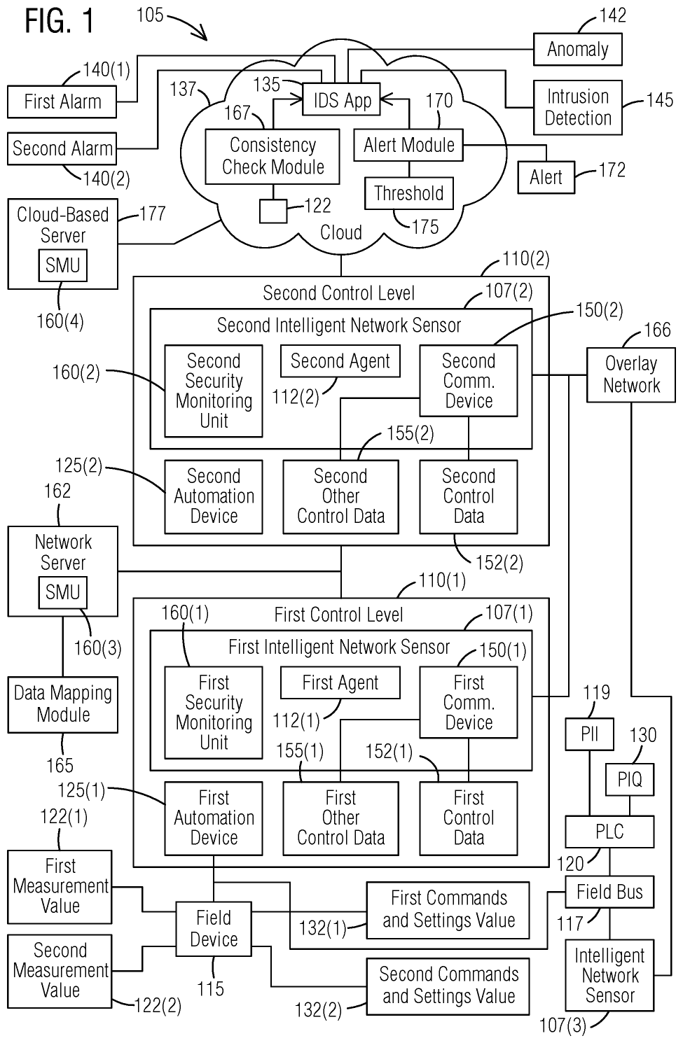

These and other embodiments of an automation system according to the present disclosure are described below with reference to FIGS. 1-10 herein. Like reference numerals used in the drawings identify similar or identical elements throughout the several views. The drawings are not necessarily drawn to scale.

Consistent with one embodiment of the present invention, FIG. 1 represents a block diagram of an automation and control system 105 that provides a multilevel consistency check-based cyber security solution for industrial control systems (ICS) in accordance with an exemplary embodiment of the present invention. For anomaly detection, the automation and control system 105 comprises a plurality of intelligent network sensors, wherein at least two of the intelligent network sensors (e.g., a first intelligent network sensor 107(1) and a second intelligent network sensor 107(2)) are placed at different control levels 110 of the automation and control system 105. The control levels comprise a first control level 110(1) and a second control level 110(2).

The first intelligent network sensor 107(1) comprises a first agent 112(1) configured to collect control data associated with a field device 115 of the automation and control system 105. The second intelligent network sensor 107(2) comprises a second agent 112(2) configured to collect control data associated with the field device 115. Each intelligent network sensor 107 is configured to read measurements from I/Os and status words from Drives directly via a fieldbus 117 connected to an intelligent network sensor 107(3). Each intelligent network sensor 107 is configured to read process image inputs (PII) 119 directly from a programmable logic controller (PLC) 120 via Ethernet. Each intelligent network sensor 107 is configured to process measurements values 122 from different automation devices (e.g., a first automation device 125(1) of the first control level 110(1) and a second automation device 125(2) of the second control level 110(2)). Each intelligent network sensor 107 is configured to read commands and settings displayed on HMIs, exchanged via an Industrial Router, a MES and a Log Server via Ethernet or WiFi. Each intelligent network sensor 107 is configured to read process image outputs (PIQ) 130 directly from the programmable logic controller (PLC) 120 via the Ethernet. Each intelligent network sensor 107 is configured to process the commands and settings values 132 from different automation devices 125.

The automation and control system 105 further comprises an Intrusion Detection System (IDS) Application (APP) 135 hosted in a cloud 137. The IDS APP 135 is configured to compare a first measurement value 122(1) associated with the field device 115 of the automation and control system 105 at the first automation device 125(1) of the first control level 110(1) with a second measurement value 122(2) associated with the field device 115 of the automation and control system 105 at the second automation device 125(2) of the second control level 110(2). The comparison might also happen simultaneously across more than 2 levels (e.g. sensor measurement on field bus, value extracted from the PLC memory, value extracted from the ethernet communication, value extracted from HMI memory. The inconsistency can also be defined not only in terms of values that are expected to be the same (e.g. sensor value measurement), but also direct sensor (and actuator) data correlations. E.g. pump is always on when level sensor is increasing on a tank. The IDS APP 135 is further configured to set a first alarm 140(1) when detecting the first measurement value 122(1) is inconsistent from the second measurement value 122(2). Aggregation of correlated alarms over time is also possible in one embodiment.

The IDS APP 135 is further configured to compare a first commands and settings value 132(1) associated with the field device 115 of the automation and control system 105 at the first automation device 125(1) of the first control level 110(1) with a second commands and settings value 132(2) associated with the field device 115 of the automation and control system 105 at the second automation device 125(2) of the second control level 110(2). The IDS APP 135 is further configured to set a second alarm 140(2) when detecting the first commands and settings value 132(1) is inconsistent from the second commands and settings value 132(2). However, nothing prevents it from triggering a single alarm for a series on detected inconsistencies. The IDS APP 135 is further configured to check measurement consistency and check commands and settings consistency. The IDS APP 135 is further configured to detect an anomaly 142 based on either the measurement consistency or the commands and settings consistency. The IDS APP 135 is further configured to identify the anomaly 142 as an intrusion detection 145.

The first intelligent network sensor 107(1) comprises a first communication device 150(1) for transmitting collected first control data 152(1) to other intelligent network sensors 107 and receiving first other control data 155(1) from other intelligent network sensors 107. The first intelligent network sensor 107(1) further comprises a first security monitoring unit 160(1) to perform data analysis.

The second intelligent network sensor 107(2) comprises a second communication device 150(2) for transmitting collected second control data 152(2) to other intelligent network sensors 107 and receiving second other control data 155(2) from other intelligent network sensors 107. The second intelligent network sensor 107(2) further comprises a second security monitoring unit 160(2) to perform data analysis. Each intelligent network sensor of the plurality of intelligent network sensors 107 is a network-based plant floor sensor and the first automation device 125(1) and the second automation device 125(2) are plant floor automation devices.

The automation and control system 105 further comprises a network server 162 comprising a security monitoring unit 160(3) to perform data analysis. The automation and control system 105 further comprises the fieldbus 117 to which at least one intelligent network sensor 107(3) is coupled. The automation and control system 105 further comprises a data mapping module 165 configured to map data from intelligent network sensors 107 deployed at multiple control levels at other plants of a common fleet. The plurality of intelligent network sensors 107 may be distributed as an overlay network 166.

The Intrusion Detection System (IDS) Application (APP) 135 comprises a consistency check module 167 configured to compare measurement values 122 on different automation devices 125 at different control levels 110 of the automation and control system 105 to detect the anomaly 142. The Intrusion Detection System (IDS) Application (APP) further comprises an alert module 170 configured to trigger an alert 172 in response to one or more anomalies 142 being detected that surpass at least one threshold 175.

The automation and control system 105 further comprises a cloud-based server 177 comprising a security monitoring unit 160(4). The security monitoring unit 160(4) comprises a data mapping module configured to map data from intelligent network sensors deployed at multiple control levels at other plants of a common fleet. The security monitoring unit 160(4) comprises a consistency check module configured to detect an anomaly based on a fleet-based analysis of control data.

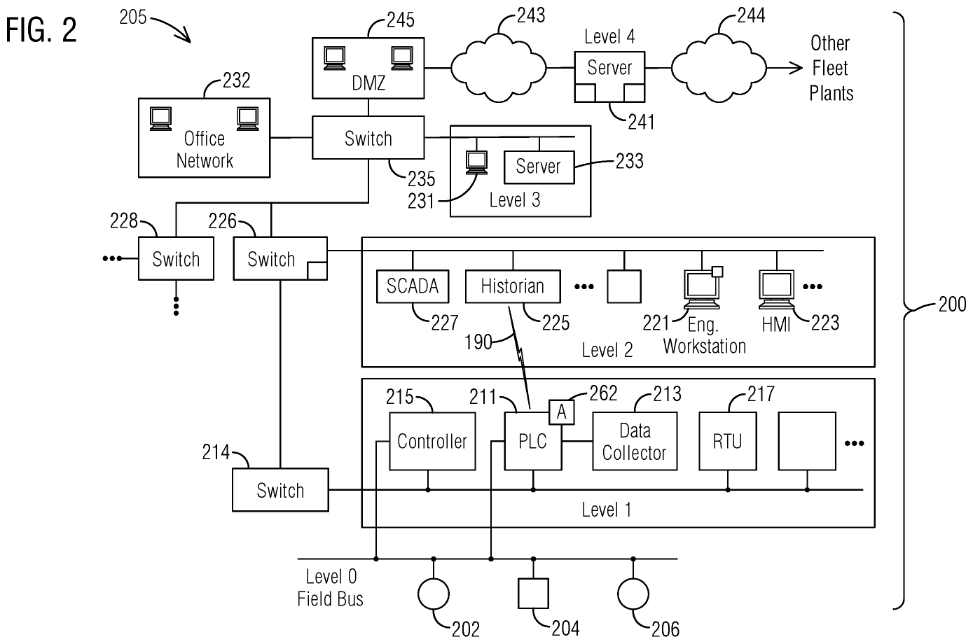

Referring to FIG. 2, it illustrates a block diagram of a multilevel intrusion detection system 205 based on the Purdue Manufacturing Model with the distinct levels (0,1,2,3,4) to detect potential cyber attacks on a plant floor network in accordance with an exemplary embodiment of the present invention. The Purdue Manufacturing Model divides an industrial control system (ICS) architecture into three zones and six levels. It is an industry adopted reference model that shows the interconnections and interdependencies of all the main components of a typical ICS. Purdue model was adopted from the Purdue Enterprise Reference Architecture (PERA) model by ISA-99 and used as a concept model for ICS network segmentation.

In an embodiment, an OT network 200 may have a plant wide structure that includes multiple control levels, such as a production scheduling control level 4, a production control level 3, a plant supervisory control level 2, a direct control level 1, and a field bus control level 0, as shown in FIG. 2. Each of the control levels may communicate according to an industrial Ethernet protocol, controlled by routers or Ethernet switches at each level. For example, switch 235 is placed within the control network to control data packet routing between control levels 3 and 4.

The control level 4 components of the OT network 200 may include one or more production scheduling servers 241 as the highest level of control for the plant wide OT network 200. The server 241 may be remotely located and connected to the OT network 200 via a network 243 such as the internet, and connected to other fleet plants via network 244. A DMZ 245 may provide a firewall between the plant control network and the external network 243.

The control level 3 components of the OT network 200 may include one or more coordinating computers 231, and one or more web servers or central archiving servers 233. An office network 232 may share a common router (the switch 235) with the control level 3 components, and may include one or more user terminals used by plant personnel to perform administrative functions that may be ancillary to plant control. However, by sharing a common path at the switch 235, the office network 232 may present a vulnerability to the OT network 200 by way of external communication via the network 243, such as the internet. For example, an office worker laptop could be victimized by a cyber attack and infected with malware that could later move laterally to potentially intercept and alter data packets in the OT network 200.

Control level 2 of the OT network 200 may perform a supervisory function for the network. The level 2 components of the OT network 200 may include one or more SCADA servers 227, one or more historian units 225, an engineering workstation 221, and a HMI unit 223. The SCADA servers 227 are useful for remote access to level 1 controllers and may serve to provide overriding functionality at a supervisory level. The historian units 225 may be embedded or external devices used for storing historical process data, such as process variable information, event information, and/or user action information, collected by a SCADA server 227 or a HMI unit 223. For example, a historian unit 225 may be implemented as a plant information management system (PIMS) device. Level 2 switches may control data packets for level 2 OT components. For example, a switch 226 may control communications to and from each of SCADA servers 227, historian units 225, engineering workstations 221, and HMIs 223 when communicating with OT components of other levels. Other level 2 switches, such as a switch 228, may be similarly placed within the OT network 200 for controlling other level 2 control components dedicated to different zones of the plant. A historian unit 225 may communicate with one or more PLCs 211 via a wireless communication link 190.

Control level 1 of the OT network 200 may include direct controllers responsible for controlling actions of field devices and for collecting sensor and measurement information related to the field devices. Control level 1 may include one or more controllers 215, one or more PLCs 211, and one or more remote telemetry units (RTUs) 217. Each of the PLCs 211 may be coupled to a data collector 213 for logging and storing historical and production data related to the field devices, such as to database storage. During plant operations, a PLC 211 may perform scan cycles of inputs and outputs, which are stored as process images for access by the SCADA server 227. The outputs may be communicated to the operator at a HMI unit such as HMI unit 223. Such data transmissions between control components at the control levels may be susceptible to a cyber attack, such as a manipulation of process view.

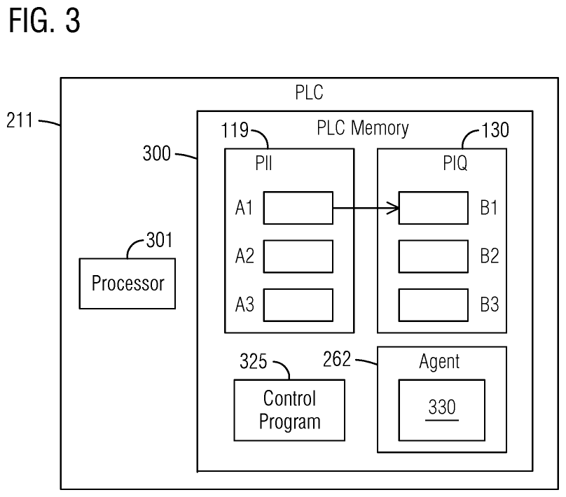

Control level 0 of the OT network 200 may include one or more field buses to which field devices, such as sensors and actuators, are connected. The signals exchanged at the field bus may be referred to as process variables, including received control instructions from the level 0 control devices, and control feedback signals, such as instrument measurements and sensor readings, sent back to the level 0 control devices. For example, a field device 202 may be controlled by the controller 215, while field devices 204, 206 are controlled by PLC 211. A control level 1 switch 214 may be implemented as an Ethernet router and/or gateway for exchanging data packets at control level 1 to control level 2. For PLCs 211 that are not Ethernet enabled, switch 214 may include a gateway for conversion of PLC data to Ethernet based data to communication with higher control level OT components, such as SCADA server 227. The interface between the controllers, such as PLC 211, and the level 0 field devices may be a serial port protocol, such as Profibus RS-485 standard protocol, which is incompatible with Ethernet. While Ethernet or industrial Ethernet is described as one possible protocol for higher levels of the OT network 200, other data transfer protocols may be applied with conversion and switching as appropriate according to the same manner as described. The Programmable Logic Controller (PLC) 211 may include an intrusion detection agent 262 which is further described with reference to FIG. 3.

Turning now to FIG. 3, which illustrates the Programmable Logic Controller (PLC) 211 with the intrusion detection agent 262 in accordance with an exemplary embodiment of the present invention. An agent 262 may be disposed in the PLC 211. As shown in FIG. 3, the agent 262 may include a software function block 330 to implement data collection at a host device, and software function blocks for execution of various types of intrusion detection. In an embodiment, the function blocks of agent 162 may be executed by a PLC processor 301. In an embodiment, the agent 262 may be implemented as an embedded computer with a separate microprocessor to execute the function blocks. The intrusion detection may be implemented via a PLC memory 300. A control program 325 includes the instructions executed by the PLC 211 for operation of connected field devices. Additionally, the control program 325 manages input/output, global variables, and access paths. The software function block 330 is configured to analyze these input/output, global variables, and access paths as they are received or modified to identify conditions which may indicate that a malicious intrusion is taking place.

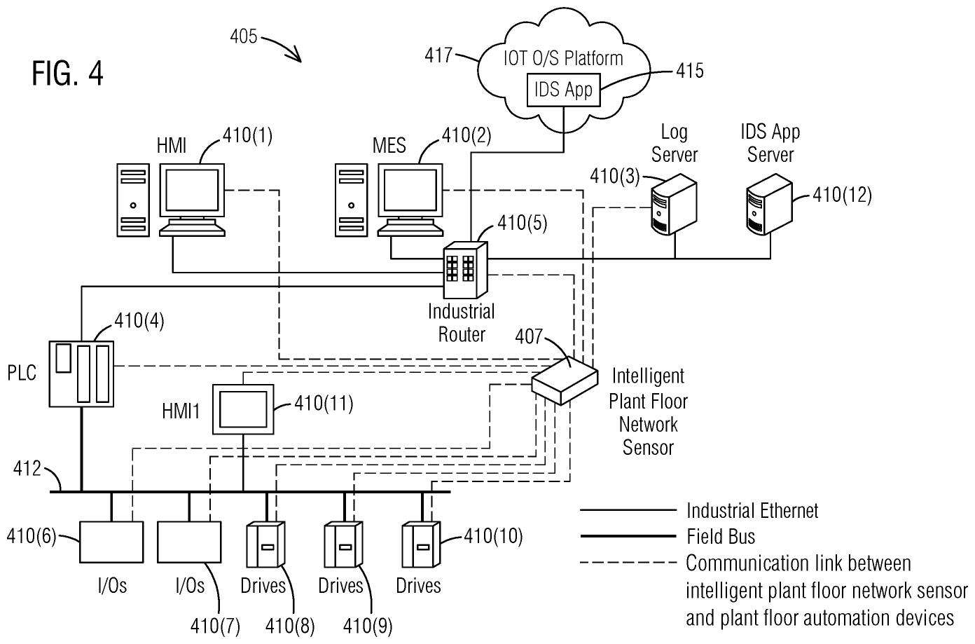

FIG. 4 illustrates an automation and control system 405 in which an Intelligent Plant Floor Network Sensor (IPFNS) 407 connects to all plant floor automation devices 410(1-n) in accordance with an exemplary embodiment of the present invention. The intelligent plant floor network sensor (IPFNS) 407 connects to all plant floor automation devices 410(1-n) via Ethernet, wireless communication link or fieldbus. For example, the IPFNS may connect a Human Machine Interface (HMI) 410(1), a manufacturing execution system (MES) 410(2), a Log Server 410(3) and a PLC 410(4) via Ethernet. The IPFNS 407 may connect an Industrial Router 410(5) via Ethernet or WiFi. The IPFNS 407 may connect I/Os 410(6-7) and Drives 410(8-10) and a HMI 410(11) via a fieldbus 412. All collected data is sent to a local IDS APP 415 located in a cloud 417 as part of an Internet of Things (IoT) operating system platform. For example, all collected data can be sent to the IDS APP 415 in the cloud 417 after being processed and zipped. However, there can also be an option of sending those security alarms directly to the SCADA server to be displayed at the operator HMI.

In order to check measurement consistency, the IPFNS 407 is configured to work as follows: reads measurements from I/Os 410(6-7) and status words from Drives 410(8-10) directly via the fieldbus 412; reads process the image inputs (PII) 119 directly from PLC 211 via the Ethernet; reads measurements displayed on the HMIs 410(1) and 410(11), exchanged via the Industrial Router 410(5), the MES 410(2) and the Log Server 410(3) via the Ethernet or WiFi; processes measurements values from different devices compares measurement values on different devices 410 in the local IDS APP 415—set alarm when detecting inconsistent measurement values; and performs in-depth data analysis (forensic analysis), which need more computational power, can be performed in the IDS APP 415 hosted in the cloud 417 or hosted in an IDS APP server 410(12). Those alerts can otherwise be output to a SIEM (security information and event management system).

In order to check consistency of commands and settings, the IPFNS 407 is configured to work as follows: reads commands/settings displayed on the HMIs 410(1) and 410(11), exchanged via the Industrial Router 410(5), the MES 410(2) and the Log Server 410(3) via the Ethernet or WiFi; reads process the image outputs (PIQ) 130 directly from PLC 211 via the Ethernet; reads measurements from I/Os 410(6-7) and control words from Drives 410(8-10) directly via the fieldbus 412; processes commands/settings values from different devices 410; and compares commands/settings values on different devices 410 to set one or more alarms when detecting inconsistent commands/settings values. This measurement consistency check and consistency of commands and settings check can detect fault data injection, especially faked commands/settings and measurements on the fieldbus 412 and the plant floor Ethernet.

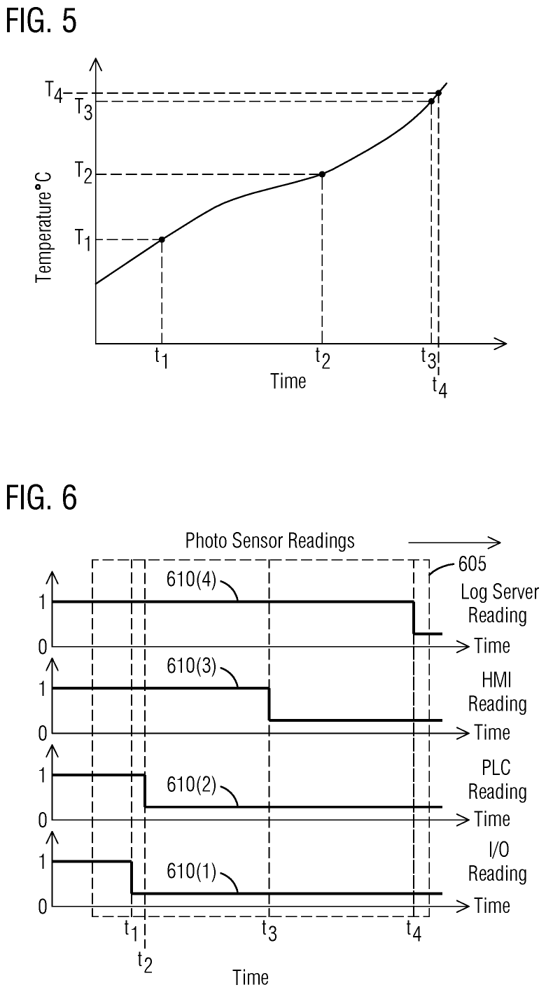

As seen in FIG. 5, it illustrates temperature sensor measurement readings on different devices 410 in accordance with an exemplary embodiment of the present invention. One sensor measurement on different devices 410 may be different, even they are sensed by the IPFNS 407 at the same time. As shown in FIG. 5, a temperature sensor collects temperature measurement continuously and sends the value to the PLC 211 every 10 milliseconds, the PLC 211 sends the measurement value to the HMI 410(1), via the Industrial Router 410(5) to the HMI 410(1) every 200 milliseconds and the HMI 410(1) sends the measurement value to the Log Server 410(3) every 1 second.

At moment t4, assume that the IPFNS 407 reads temperature readings on the I/O 410(6), the PLC 211, the HMI 410″(1) and the Log Server 410(3) at the same time. The readings are different—T4, T3, T2 and T1 are readings of the same temperature sensor on the I/O 410(6), the PLC 211, the HMI 410(1) and the Log Server 410(3), respectively. And they are readings on the I/O 410(6) at different moments t4, t3, t2 and t1, respectively. Therefore, there is “unsync” issue of the same sensor 407 readings on different devices 410. Furthermore, the IPFNS 407 cannot read all readings on different devices 410 at the same time, usually it reads them sequentially. Thus, this even makes those readings more “unsync”.

The following method addresses this “unsync” issue. Before comparing these analog readings of the same sensor 407 measurement on different devices 410—1) use the reading in the PLC 211 as a baseline, since all control comes from the PLC 211; 2) use a previous reading (10 milliseconds ago) of I/Os 410(6-7); 3) use the previous reading and readings in the HMI 410(1) and calculate a current reading by extrapolating; and 4) use the previous reading and readings in the Log Server 410(3) and calculate a current reading by extrapolating.

When these readings, including calculated ones, are compared, a threshold is used to decide the readings of this sensor 407 is normal or abnormal. For instance, the method can take advantage of production process domain knowledge that the temperature of this product cannot be changed 2° C. in one second. Then the method may set the threshold of comparison to 0.5° C.

For digital measurements, such as pressure high and low, water level high and low, the method proposes use of a sliding window to check data. The following example of a photo sensor is presented to explain how the proposed sliding window works.

As shown in FIG. 6, it illustrates a sliding window 605 of a photo sensor's readings 610(1-4) in accordance with an exemplary embodiment of the present invention. A photo sensor's reading 610(1) in an I/O module 410(6) turns 0 from 1 at t1, the reading in PII of the PLC 211 changes from 1 to 0 at t2, and this reading can be seen on the HMI 410(1) and the Log Server 410(3) at t3 and t4, respectively. The sliding window 605 is configured to perform this photo sensor reading check. Note that: 1) the sliding window 605 size should be a little greater that the maximum delay of updating of sensor measurement in the Log Server 410(3), e.g. the size should be t4−t1+δ, whereas δ is greater than 0; and 2) the sliding window 605 moves along the axis of time, the method proposes that the reading time of I/O is used as the right edge of the sliding window 605.

It is more complicated to check consistency of settings and commands on different devices 410. Usually, the MES 410(2) downloads production recipes to the PLC 211 and the HMI 410(1). The operators are able to modify or just validate the settings and commands from the MES 410(2). After that, the modified settings/commands are downloaded to the PLC 211. The PLC 211 sends commands and settings to sensors and drives according to the production process status.

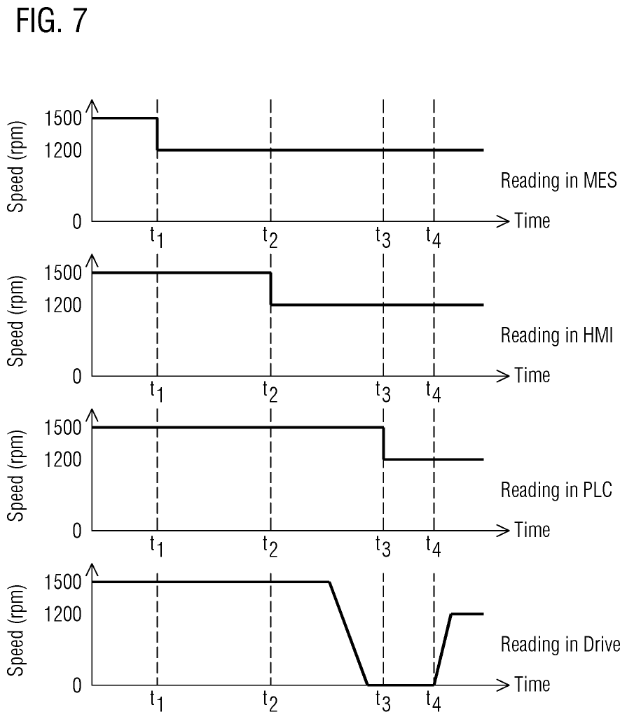

In FIG. 7, it illustrates speed setting readings on different devices 410 in accordance with an exemplary embodiment of the present invention. As shown in FIG. 7, a drive speed setting read on different devices 410 can be different too. For instance, the operator configures setting 1200 rpm for a new batch of products on the MES 410(2) at t1. And at t2, the operator validates this setting on the HMI 410(1), and downloads it to the PLC 211 at t3. However, at t1, the drive speed setting 1500 rpm is still for the current batch under production. After the current batch is finished, the speed setting in drive is slowed down continuously to 0. At t4, the speed setting in the drive is increased gradually to 1200 rpm. In this case, the method proposes to use the stable speed setting in the drive as the baseline, and again use a sliding window to compare the settings in the PLC 211, the HMI 410(1) and the MES 410(2). It is possible to compare the acceleration settings as well.

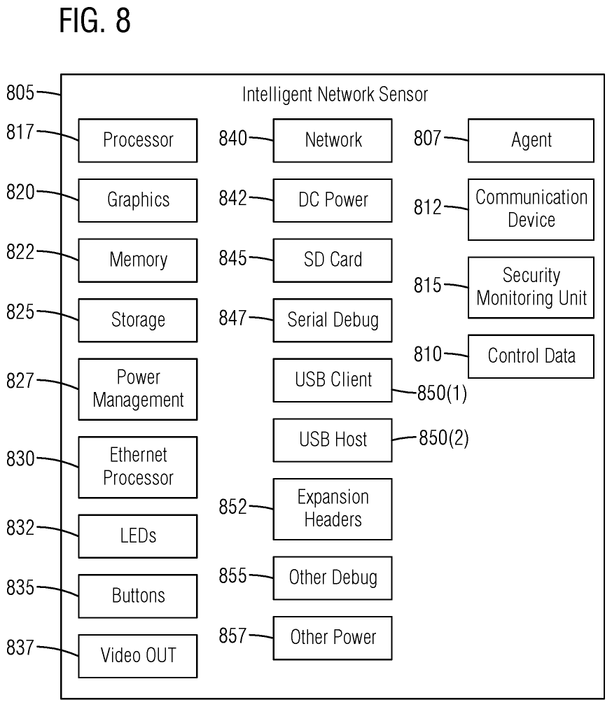

With regards to FIG. 8, it illustrates an Intelligent Plant Floor Network Sensor (IPFNS) 805 in accordance with an exemplary embodiment of the present invention. The Intelligent Plant Floor Network Sensor (IPFNS) 805 may be built based on BeagleBone Black board or Raspberry PI board. The IPFNS 805 is a compact, low-cost, open-source Linux computing platform that can be used to build complex applications that interface high-level software and low-level electronic circuits. The IPFNS 805 platform hardware includes various subsystems and physical inputs/outputs of the board. In addition, it includes accessories of this computing platform. The IPFNS 805 uses the Texas Instruments Sitara AM335x Cortex A8 ARM microprocessor. The IPFNS 805 runs the Linux operating system, which means that you can use many open-source software libraries and applications directly with it. It takes advantage of the power and freedom of Linux, combined with direct access to input/output pins and buses, allowing one to interface with electronics components, modules, and USB devices. One can modify the hardware and software of such a small yet powerful device and adapt it.

The IPFNS 805 is a powerful single-board computer (SBC), and while there are other SBCs available on the market such as the Raspberry PI and the Intel Galileo, the IPFNS 805 has one key differentiator—it was built to be interfaced to! For example, the IPFNS 805's microprocessor even contains two additional on-chip microcontrollers that can be used for real-time interfacing—an area in which other Linux SBCs have significant difficulty. Unlike most other SBCs, the IPFNS 805 is fully open source hardware. The BeagleBoard.org Foundation provides source schematics, hardware layout, a full bill of materials, and technical reference manuals, enabling you to modify the design of the BeagleBone platform.

It is the ability of the IPFNS 805 to run embedded Linux that makes the resulting platform accessible, adaptable, and powerful. Together, Linux and embedded systems enable ease of development for devices for the Internet of Things (IoT). The integration of high-level Linux software and low-level electronics represents a paradigm shift in embedded systems development. It is revolutionary that one can build a low-level electronics circuit and then install a Linux web server, using only a few short commands, so that the circuit can be controlled over the Internet. One can easily use the IPFNS 805 as a general-purpose Linux computer.

The Intelligent Plant Floor Network Sensor (IPFNS) 805 comprises an agent 807 configured to collect control data 810 associated with the field device 115 of the automation and control system 105. The Intelligent Plant Floor Network Sensor (IPFNS) 805 further comprises a communication device 812 for transmitting collected control data 810 to other intelligent network sensors and receiving control data from other intelligent network sensors. The Intelligent Plant Floor Network Sensor (IPFNS) 805 further comprises a security monitoring unit 815 to perform data analysis.

The Intelligent Plant Floor Network Sensor (IPFNS) 805 further comprises a processor 817, a graphics 820, a memory 822, a storage 825, a power management 827, an Ethernet processor 830, LEDs 832, buttons 835, a video out 837, a network 840, a DC power 842, a SD card 845, a serial debug 847, a USB client 850(1), a USB host 850(2), expansion headers 852, other debug 855 and other power 857. The Intelligent Plant Floor Network Sensor (IPFNS) 805 may be a network-based plant floor sensor. The Intelligent Plant Floor Network Sensor (IPFNS) 805 may be distributed as an overlay network.

At least two Intelligent Plant Floor Network Sensors (IPFNSs) 805 may be placed at different control levels of the automation and control system 105 to assist in anomaly detection in the automation and control system 105 such that the control levels comprise a first control level and a second control level. Each Intelligent Plant Floor Network Sensor (IPFNS) 805 to read measurements from I/Os and status words from Drives directly via a fieldbus, read process image inputs (PII) directly from a programmable logic controller (PLC) via Ethernet, process measurements values from different automation devices, read commands and settings displayed on HMIs, exchanged via an Industrial Router, a MES and a Log Server via Ethernet or WiFi, read process image outputs (PIQ) directly from a programmable logic controller (PLC) via the Ethernet, and process commands and settings values from different automation devices.

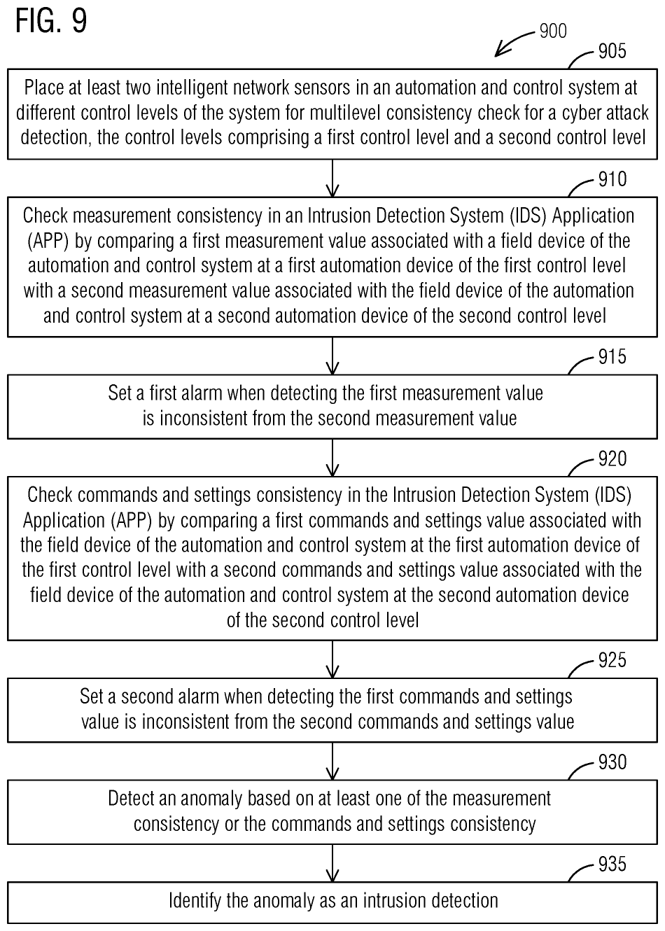

With respect to FIG. 9, it illustrates a schematic view of a flow chart of a method 900 of anomaly detection in the automation and control system 105 in accordance with an exemplary embodiment of the present invention. Reference is made to the elements and features described in FIGS. 1-8. It should be appreciated that some steps are not required to be performed in any particular order, and that some steps are optional.

The method 900 comprises a step 905 of placing at least two Intelligent Plant Floor Network Sensors (IPFNSs) 805 in the automation and control system 105 at different control levels 110 of the system 105. The control levels 110 include the first control level 110(1) and the second control level 110(2). The method 900 further comprises a step 910 of checking measurement consistency in the Intrusion Detection System (IDS) Application (APP) 415 by comparing the first measurement value 122(1) associated with the field device 115 of the automation and control system 105 at the first automation device 125(1) of the first control level 110(1) with the second measurement value 122(2) associated with the field device 115 of the automation and control system 105 at the second automation device 125(2) of the second control level 110(2).

The method 900 further comprises a step 915 of setting the first alarm 140(1) when detecting the first measurement value 122(1) is inconsistent from the second measurement value 122(2). The method 900 further comprises a step 920 of checking commands and settings consistency in the Intrusion Detection System (IDS) Application (APP) 415 by comparing the first commands and settings value 132(1) associated with the field device 115 of the automation and control system 105 at the first automation device 125(1) of the first control level 110(1) with the second commands and settings value 132(2) associated with the field device 115 of the automation and control system 105 at the second automation device 125(2) of the second control level 110(2). The method 900 further comprises a step 925 of setting the second alarm 140(2) when detecting the first commands and settings value 132(1) is inconsistent from the second commands and settings value 132(2).

The method 900 further comprises a step 930 of detecting the anomaly 142 based on at least one of the measurement consistency or the commands and settings consistency. The method 900 further comprises a step 935 of identifying the anomaly 142 as the intrusion detection 145.

The checking measurement consistency and checking commands and settings consistency is performed by at least two Intelligent Plant Floor Network Sensors (IPFNSs) 805 distributed as an overlay network. In the method 900, checking measurement consistency comprises reading measurements from I/Os and status words from Drives directly via a fieldbus, reading process image inputs (PII) directly from a programmable logic controller (PLC) via Ethernet, processing measurements values from different automation devices, performing data analysis in the IDS APP hosted in a cloud. In the method 900, checking measurement consistency further comprises using a reading in a programmable logic controller (PLC) as a baseline, using a previous reading of I/Os, using the previous reading and the reading in HMI and calculating a current reading by extrapolating and using the previous reading and the reading in a Log Server and calculating a current reading by extrapolating.

In the method 900, checking commands and settings consistency comprises reading commands and settings displayed on HMIs, exchanged via an Industrial Router, a MES and a Log Server via Ethernet or WiFi, reading process image outputs (PIQ) directly from a programmable logic controller (PLC) via the Ethernet, reading measurements from I/Os and control words from Drives directly via a fieldbus, and processing commands and settings values from different automation devices.

Since the proposed solution requires to access data at level 0 and level 1, traditional IT security companies may not be able to access and obtain this data. The proposed method also requires production process domain knowledge, such as refinery, fossil-based power plants and chemical plants, to process sensor measurements, commands and settings. A value-added, cloud-based security service can be created based on the proposed method.

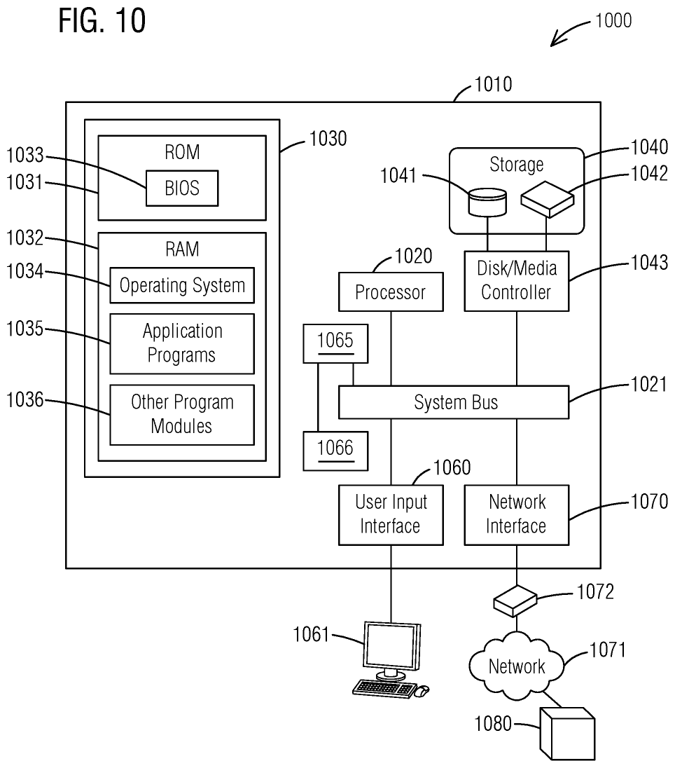

FIG. 10 shows an example of a computing environment 1000 within which embodiments of the disclosure may be implemented. The computing environment 1000 includes a computer system 1010 that may include a communication mechanism such as a system bus 1021 or other communication mechanism for communicating information within the computer system 1010. The computer system 1010 further includes one or more processors 1020 coupled with the system bus 1021 for processing the information.

The processors 1020 may include one or more central processing units (CPUs), graphical processing units (GPUs), or any other processor known in the art. More generally, a processor as described herein is a device for executing machine-readable instructions stored on a computer readable medium, for performing tasks and may comprise any one or combination of, hardware and firmware. A processor may also comprise memory storing machine-readable instructions executable for performing tasks. A processor acts upon information by manipulating, analyzing, modifying, converting or transmitting information for use by an executable procedure or an information device, and/or by routing the information to an output device. A processor may use or comprise the capabilities of a computer, controller or microprocessor, for example, and be conditioned using executable instructions to perform special purpose functions not performed by a general purpose computer. A processor may include any type of suitable processing unit including, but not limited to, a central processing unit, a microprocessor, a Reduced Instruction Set Computer (RISC) microprocessor, a Complex Instruction Set Computer (CISC) microprocessor, a microcontroller, an Application Specific Integrated Circuit (ASIC), a Field-Programmable Gate Array (FPGA), a System-on-a-Chip (SoC), a digital signal processor (DSP), and so forth. Further, the processor(s) 1020 may have any suitable microarchitecture design that includes any number of constituent components such as, for example, registers, multiplexers, arithmetic logic units, cache controllers for controlling read/write operations to cache memory, branch predictors, or the like. The microarchitecture design of the processor may be capable of supporting any of a variety of instruction sets. A processor may be coupled (electrically and/or as comprising executable components) with any other processor enabling interaction and/or communication there-between. A user interface processor or generator is a known element comprising electronic circuitry or software or a combination of both for generating display images or portions thereof. A user interface comprises one or more display images enabling user interaction with a processor or other device.

The system bus 1021 may include at least one of a system bus, a memory bus, an address bus, or a message bus, and may permit exchange of information (e.g., data (including computer-executable code), signaling, etc.) between various components of the computer system 1010. The system bus 1021 may include, without limitation, a memory bus or a memory controller, a peripheral bus, an accelerated graphics port, and so forth. The system bus 1021 may be associated with any suitable bus architecture including, without limitation, an Industry Standard Architecture (ISA), a Micro Channel Architecture (MCA), an Enhanced ISA (EISA), a Video Electronics Standards Association (VESA) architecture, an Accelerated Graphics Port (AGP) architecture, a Peripheral Component Interconnects (PCI) architecture, a PCI-Express architecture, a Personal Computer Memory Card International Association (PCMCIA) architecture, a Universal Serial Bus (USB) architecture, and so forth.

Continuing with reference to FIG. 10, the computer system 1010 may also include a system memory 1030 coupled to the system bus 1021 for storing information and instructions to be executed by processors 1020. The system memory 1030 may include computer readable storage media in the form of volatile and/or nonvolatile memory, such as read only memory (ROM) 1031 and/or random access memory (RAM) 1032. The RAM 1032 may include other dynamic storage device(s) (e.g., dynamic RAM, static RAM, and synchronous DRAM). The ROM 1031 may include other static storage device(s) (e.g., programmable ROM, erasable PROM, and electrically erasable PROM). In addition, the system memory 1030 may be used for storing temporary variables or other intermediate information during the execution of instructions by the processors 1020. A basic input/output system 1033 (BIOS) containing the basic routines that help to transfer information between elements within computer system 1010, such as during start-up, may be stored in the ROM 1031. RAM 1032 may contain data and/or program modules that are immediately accessible to and/or presently being operated on by the processors 1020. System memory 1030 may additionally include, for example, operating system 1034, application programs 1035, and other program modules 1036. Application programs 1035 may also include a user portal for development of the application program, allowing input parameters to be entered and modified as necessary.

The operating system 1034 may be loaded into the memory 1030 and may provide an interface between other application software executing on the computer system 1010 and hardware resources of the computer system 1010. More specifically, the operating system 1034 may include a set of computer-executable instructions for managing hardware resources of the computer system 1010 and for providing common services to other application programs (e.g., managing memory allocation among various application programs). In certain example embodiments, the operating system 1034 may control execution of one or more of the program modules depicted as being stored in the data storage 1040. The operating system 1034 may include any operating system now known or which may be developed in the future including, but not limited to, any server operating system, any mainframe operating system, or any other proprietary or non-proprietary operating system.

The computer system 1010 may also include a disk/media controller 1043 coupled to the system bus 1021 to control one or more storage devices for storing information and instructions, such as a magnetic hard disk 1041 and/or a removable media drive 1042 (e.g., floppy disk drive, compact disc drive, tape drive, flash drive, and/or solid state drive). Storage devices 1040 may be added to the computer system 1010 using an appropriate device interface (e.g., a small computer system interface (SCSI), integrated device electronics (IDE), Universal Serial Bus (USB), or FireWire). Storage devices 1041, 1042 may be external to the computer system 1010.

The computer system 1010 may also include a field device interface 1065 coupled to the system bus 1021 to control a field device 1066, such as a device used in a production line. The computer system 1010 may include a user input interface 1060 or GUI coupled to a user input device 1061, which may comprise one or more input devices, such as a keyboard, touchscreen, tablet and/or a pointing device, for interacting with a computer user and providing information to the processors 1020.

The computer system 1010 may perform a portion or all of the processing steps of embodiments of the invention in response to the processors 1020 executing one or more sequences of one or more instructions contained in a memory, such as the system memory 1030. Such instructions may be read into the system memory 1030 from another computer readable medium of storage 1040, such as the magnetic hard disk 1041 or the removable media drive 1042. The magnetic hard disk 1041 and/or removable media drive 1042 may contain one or more data stores and data files used by embodiments of the present disclosure. The data store 1040 may include, but are not limited to, databases (e.g., relational, object-oriented, etc.), file systems, flat files, distributed data stores in which data is stored on more than one node of a computer network, peer-to-peer network data stores, or the like. The data stores may store various types of data such as, for example, skill data, sensor data, or any other data generated in accordance with the embodiments of the disclosure. Data store contents and data files may be encrypted to improve security. The processors 1020 may also be employed in a multi-processing arrangement to execute the one or more sequences of instructions contained in system memory 1030. In alternative embodiments, hard-wired circuitry may be used in place of or in combination with software instructions. Thus, embodiments are not limited to any specific combination of hardware circuitry and software.

As stated above, the computer system 1010 may include at least one computer readable medium or memory for holding instructions programmed according to embodiments of the invention and for containing data structures, tables, records, or other data described herein. The term “computer readable medium” as used herein refers to any medium that participates in providing instructions to the processors 1020 for execution. A computer readable medium may take many forms including, but not limited to, non-transitory, non-volatile media, volatile media, and transmission media. Non-limiting examples of non-volatile media include optical disks, solid state drives, magnetic disks, and magneto-optical disks, such as magnetic hard disk 1041 or removable media drive 1042. Non-limiting examples of volatile media include dynamic memory, such as system memory 1030. Non-limiting examples of transmission media include coaxial cables, copper wire, and fiber optics, including the wires that make up the system bus 1021. Transmission media may also take the form of acoustic or light waves, such as those generated during radio wave and infrared data communications.

Computer readable medium instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, may be implemented by computer readable medium instructions.

The computing environment 1000 may further include the computer system 1010 operating in a networked environment using logical connections to one or more remote computers, such as remote computing device 1080. The network interface 1070 may enable communication, for example, with other remote devices 1080 or systems and/or the storage devices 1041, 1042 via the network 1071. Remote computing device 1080 may be a personal computer (laptop or desktop), a mobile device, a server, a router, a network PC, a peer device or other common network node, and typically includes many or all of the elements described above relative to computer system 1010. When used in a networking environment, computer system 1010 may include modem 1072 for establishing communications over a network 1071, such as the Internet. Modem 1072 may be connected to system bus 1021 via user network interface 1070, or via another appropriate mechanism.

Network 1071 may be any network or system generally known in the art, including the Internet, an intranet, a local area network (LAN), a wide area network (WAN), a metropolitan area network (MAN), a direct connection or series of connections, a cellular telephone network, or any other network or medium capable of facilitating communication between computer system 1010 and other computers (e.g., remote computing device 1080). The network 1071 may be wired, wireless or a combination thereof. Wired connections may be implemented using Ethernet, Universal Serial Bus (USB), RJ-6, or any other wired connection generally known in the art. Wireless connections may be implemented using Wi-Fi, WiMAX, and Bluetooth, infrared, cellular networks, satellite or any other wireless connection methodology generally known in the art. Additionally, several networks may work alone or in communication with each other to facilitate communication in the network 1071.

It should be appreciated that the program modules, applications, computer-executable instructions, code, or the like depicted in FIG. 10 as being stored in the system memory 1030 are merely illustrative and not exhaustive and that processing described as being supported by any particular module may alternatively be distributed across multiple modules or performed by a different module. In addition, various program module(s), script(s), plug-in(s), Application Programming Interface(s) (API(s)), or any other suitable computer-executable code hosted locally on the computer system 1010, the remote device 1080, and/or hosted on other computing device(s) accessible via one or more of the network(s) 1071, may be provided to support functionality provided by the program modules, applications, or computer-executable code depicted in FIG. 10 and/or additional or alternate functionality. Further, functionality may be modularized differently such that processing described as being supported collectively by the collection of program modules depicted in FIG. 10 may be performed by a fewer or greater number of modules, or functionality described as being supported by any particular module may be supported, at least in part, by another module. In addition, program modules that support the functionality described herein may form part of one or more applications executable across any number of systems or devices in accordance with any suitable computing model such as, for example, a client-server model, a peer-to-peer model, and so forth. In addition, any of the functionality described as being supported by any of the program modules depicted in FIG. 10 may be implemented, at least partially, in hardware and/or firmware across any number of devices.

It should further be appreciated that the computer system 1010 may include alternate and/or additional hardware, software, or firmware components beyond those described or depicted without departing from the scope of the disclosure. More particularly, it should be appreciated that software, firmware, or hardware components depicted as forming part of the computer system 1010 are merely illustrative and that some components may not be present or additional components may be provided in various embodiments. While various illustrative program modules have been depicted and described as software modules stored in system memory 1030, it should be appreciated that functionality described as being supported by the program modules may be enabled by any combination of hardware, software, and/or firmware. It should further be appreciated that each of the above-mentioned modules may, in various embodiments, represent a logical partitioning of supported functionality. This logical partitioning is depicted for ease of explanation of the functionality and may not be representative of the structure of software, hardware, and/or firmware for implementing the functionality. Accordingly, it should be appreciated that functionality described as being provided by a particular module may, in various embodiments, be provided at least in part by one or more other modules. Further, one or more depicted modules may not be present in certain embodiments, while in other embodiments, additional modules not depicted may be present and may support at least a portion of the described functionality and/or additional functionality. Moreover, while certain modules may be depicted and described as sub-modules of another module, in certain embodiments, such modules may be provided as independent modules or as sub-modules of other modules.

Although specific embodiments of the disclosure have been described, one of ordinary skill in the art will recognize that numerous other modifications and alternative embodiments are within the scope of the disclosure. For example, any of the functionality and/or processing capabilities described with respect to a particular device or component may be performed by any other device or component. Further, while various illustrative implementations and architectures have been described in accordance with embodiments of the disclosure, one of ordinary skill in the art will appreciate that numerous other modifications to the illustrative implementations and architectures described herein are also within the scope of this disclosure. In addition, it should be appreciated that any operation, element, component, data, or the like described herein as being based on another operation, element, component, data, or the like can be additionally based on one or more other operations, elements, components, data, or the like. Accordingly, the phrase “based on,” or variants thereof, should be interpreted as “based at least in part on.”

Although embodiments have been described in language specific to structural features and/or methodological acts, it is to be understood that the disclosure is not necessarily limited to the specific features or acts described. Rather, the specific features and acts are disclosed as illustrative forms of implementing the embodiments. Conditional language, such as, among others, “can,” “could,” “might,” or “may,” unless specifically stated otherwise, or otherwise understood within the context as used, is generally intended to convey that certain embodiments could include, while other embodiments do not include, certain features, elements, and/or steps. Thus, such conditional language is not generally intended to imply that features, elements, and/or steps are in any way required for one or more embodiments or that one or more embodiments necessarily include logic for deciding, with or without user input or prompting, whether these features, elements, and/or steps are included or are to be performed in any particular embodiment.

The flowchart and block diagrams in the Figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

While industrial control systems and devices at level 0 and level 1 are described here a range of one or more other types of automation systems or other forms of automation systems are also contemplated by the present invention. For example, other types of automation systems may be implemented based on one or more features presented above without deviating from the spirit of the present invention.

The techniques described herein can be particularly useful for programmable logic controllers (PLCs). While particular embodiments are described in terms of the programmable logic controller (PLC), the techniques described herein are not limited to a programmable logic controller (PLC) but can also be used with other automation controllers.

While embodiments of the present invention have been disclosed in exemplary forms, it will be apparent to those skilled in the art that many modifications, additions, and deletions can be made therein without departing from the spirit and scope of the invention and its equivalents, as set forth in the following claims.

Embodiments and the various features and advantageous details thereof are explained more fully with reference to the non-limiting embodiments that are illustrated in the accompanying drawings and detailed in the following description. Descriptions of well-known starting materials, processing techniques, components and equipment are omitted so as not to unnecessarily obscure embodiments in detail. It should be understood, however, that the detailed description and the specific examples, while indicating preferred embodiments, are given by way of illustration only and not by way of limitation. Various substitutions, modifications, additions and/or rearrangements within the spirit and/or scope of the underlying inventive concept will become apparent to those skilled in the art from this disclosure.

As used herein, the terms “comprises,” “comprising,” “includes,” “including,” “has,” “having” or any other variation thereof, are intended to cover a non-exclusive inclusion. For example, a process, article, or apparatus that comprises a list of elements is not necessarily limited to only those elements but may include other elements not expressly listed or inherent to such process, article, or apparatus.

Additionally, any examples or illustrations given herein are not to be regarded in any way as restrictions on, limits to, or express definitions of, any term or terms with which they are utilized. Instead, these examples or illustrations are to be regarded as being described with respect to one particular embodiment and as illustrative only. Those of ordinary skill in the art will appreciate that any term or terms with which these examples or illustrations are utilized will encompass other embodiments which may or may not be given therewith or elsewhere in the specification and all such embodiments are intended to be included within the scope of that term or terms.

In the foregoing specification, the invention has been described with reference to specific embodiments. However, one of ordinary skill in the art appreciates that various modifications and changes can be made without departing from the scope of the invention. Accordingly, the specification and figures are to be regarded in an illustrative rather than a restrictive sense, and all such modifications are intended to be included within the scope of invention.

Although the invention has been described with respect to specific embodiments thereof, these embodiments are merely illustrative, and not restrictive of the invention. The description herein of illustrated embodiments of the invention is not intended to be exhaustive or to limit the invention to the precise forms disclosed herein (and in particular, the inclusion of any particular embodiment, feature or function is not intended to limit the scope of the invention to such embodiment, feature or function). Rather, the description is intended to describe illustrative embodiments, features and functions in order to provide a person of ordinary skill in the art context to understand the invention without limiting the invention to any particularly described embodiment, feature or function. While specific embodiments of, and examples for, the invention are described herein for illustrative purposes only, various equivalent modifications are possible within the spirit and scope of the invention, as those skilled in the relevant art will recognize and appreciate. As indicated, these modifications may be made to the invention in light of the foregoing description of illustrated embodiments of the invention and are to be included within the spirit and scope of the invention. Thus, while the invention has been described herein with reference to particular embodiments thereof, a latitude of modification, various changes and substitutions are intended in the foregoing disclosures, and it will be appreciated that in some instances some features of embodiments of the invention will be employed without a corresponding use of other features without departing from the scope and spirit of the invention as set forth. Therefore, many modifications may be made to adapt a particular situation or material to the essential scope and spirit of the invention.

Respective appearances of the phrases “in one embodiment,” “in an embodiment,” or “in a specific embodiment” or similar terminology in various places throughout this specification are not necessarily referring to the same embodiment. Furthermore, the particular features, structures, or characteristics of any particular embodiment may be combined in any suitable manner with one or more other embodiments. It is to be understood that other variations and modifications of the embodiments described and illustrated herein are possible in light of the teachings herein and are to be considered as part of the spirit and scope of the invention.

In the description herein, numerous specific details are provided, such as examples of components and/or methods, to provide a thorough understanding of embodiments of the invention. One skilled in the relevant art will recognize, however, that an embodiment may be able to be practiced without one or more of the specific details, or with other apparatus, systems, assemblies, methods, components, materials, parts, and/or the like. In other instances, well-known structures, components, systems, materials, or operations are not specifically shown or described in detail to avoid obscuring aspects of embodiments of the invention. While the invention may be illustrated by using a particular embodiment, this is not and does not limit the invention to any particular embodiment and a person of ordinary skill in the art will recognize that additional embodiments are readily understandable and are a part of this invention.

It will also be appreciated that one or more of the elements depicted in the drawings/figures can also be implemented in a more separated or integrated manner, or even removed or rendered as inoperable in certain cases, as is useful in accordance with a particular application.

Benefits, other advantages, and solutions to problems have been described above with regard to specific embodiments. However, the benefits, advantages, solutions to problems, and any component(s) that may cause any benefit, advantage, or solution to occur or become more pronounced are not to be construed as a critical, required, or essential feature or component.

What is claimed is:

1. A computer-based method for multilevel consistency check for a cyber attack detection in an automation and control system, the method comprising:
placing at least two intelligent network sensors in the automation and control system at different control levels of the system, the control levels comprising a first control level and a second control level;
checking measurement consistency in an Intrusion Detection System (IDS) Application (APP) by comparing a first measurement value associated with a field device of the automation and control system at a first automation device of the first control level with a second measurement value associated with the field device of the automation and control system at a second automation device of the second control level;
setting a first alarm when detecting the first measurement value is inconsistent from the second measurement value;
checking commands and settings consistency in the Intrusion Detection System (IDS) Application (APP) by comparing a first commands and settings value associated with the field device of the automation and control system at the first automation device of the first control level with a second commands and settings value associated with the field device of the automation and control system at the second automation device of the second control level;
setting a second alarm when detecting the first commands and settings value is inconsistent from the second commands and settings value;
detecting an anomaly based on at least one of the measurement consistency or the commands and settings consistency; and
identifying the anomaly as an intrusion detection.

2. The method of claim 1, wherein the first control level is a fieldbus control level, and the second control level is a direct control level and wherein the control levels further comprise a production scheduling control level, and a production control level.

3. The method of claim 1, wherein the checking measurement consistency and the checking commands and settings consistency is performed by the at least two intelligent network sensors distributed as an overlay network.

4. The method of claim 1, wherein the checking measurement consistency comprises:
reading measurements from I/Os and status words from Drives directly via a fieldbus.

5. The method of claim 4, wherein the checking measurement consistency comprises:
reading process image inputs (PII) directly from a programmable logic controller (PLC) via Ethernet.

6. The method of claim 5, wherein the checking measurement consistency comprises:
processing measurements values from different automation devices.

7. The method of claim 6, wherein the checking measurement consistency comprises:
performing data analysis in the IDS APP hosted in a cloud.

8. The method of claim 1, wherein the checking measurement consistency comprises:
using a reading in a programmable logic controller (PLC) as a baseline;
using a previous reading of I/Os;
using the previous reading and the reading in HMI and calculating a current reading by extrapolating; and
using the previous reading and the reading in a Log Server and calculating a current reading by extrapolating.

9. The method of claim 1, wherein the checking commands and settings consistency comprises:
reading commands and settings displayed on HMIs, exchanged via an Industrial Router, a MES and a Log Server via Ethernet or WiFi.

10. The method of claim 9, wherein the checking commands and settings consistency comprises:
reading process image outputs (PIQ) directly from a programmable logic controller (PLC) via the Ethernet.

11. The method of claim 10, wherein the checking commands and settings consistency comprises:
reading measurements from I/Os and control words from Drives directly via a fieldbus.

12. The method of claim 11, wherein the checking commands and settings consistency comprises:
processing commands and settings values from different automation devices.

13. A system for anomaly detection in an automation and control system, comprising:
a plurality of intelligent network sensors, wherein at least two of the intelligent network sensors are placed at different control levels of the automation and control system, the control levels comprising a first control level and a second control level, wherein each intelligent network sensor comprises an agent configured to collect control data associated with a field device of the automation and control system, wherein each intelligent network sensor is configured to:
read measurements from I/Os and status words from Drives directly via a fieldbus;
read process image inputs (PII) directly from a programmable logic controller (PLC) via Ethernet;
process measurements values from different automation devices;
read commands and settings displayed on HMIs, exchanged via an Industrial Router, a MES and a Log Server via Ethernet or WiFi;
read process image outputs (PIQ) directly from a programmable logic controller (PLC) via the Ethernet;
process commands and settings values from different automation devices; and
an Intrusion Detection System (IDS) Application (APP) hosted in a cloud and configured to:
compare a first measurement value associated with a field device of the automation and control system at a first automation device of the first control level with a second measurement value associated with the field device of the automation and control system at a second automation device of the second control level;
set a first alarm when detecting the first measurement value is inconsistent from the second measurement value;
compare a first commands and settings value associated with the field device of the automation and control system at the first automation device of the first control level with a second commands and settings value associated with the field device of the automation and control system at the second automation device of the second control level;
set a second alarm when detecting the first commands and settings value is inconsistent from the second commands and settings value;
check measurement consistency and check commands and settings consistency;
detect an anomaly based on at least one of the measurement consistency or the commands and settings consistency; and
identify the anomaly as an intrusion detection.

14. The system of claim 13, wherein each intelligent network sensor comprises:
a communication device for transmitting collected control data to other intelligent network sensors and receiving control data from other intelligent network sensors; and
a security monitoring unit to perform data analysis.

15. The system of claim 13, further comprising:
a network server comprising a security monitoring unit to perform data analysis; and
a fieldbus, wherein at least one intelligent network sensor is coupled to the fieldbus.

16. The system of claim 13, wherein the Intrusion Detection System (IDS) Application (APP) comprises:
a consistency check module configured to compare measurement values on different automation devices at different control levels of the automation and control system to detect the anomaly.

17. The system of claim 13, wherein the Intrusion Detection System (IDS) Application (APP) comprises:
an alert module configured to trigger an alert in response to one or more anomalies being detected that surpass at least one threshold.

18. The system of claim 13, wherein the plurality of intelligent network sensors is distributed as an overlay network.

19. The system of claim 13, further comprising:
a cloud-based server comprising the security monitoring unit, and the security monitoring unit comprises:
a data mapping module configured to map data from intelligent network sensors deployed at multiple control levels at other plants of a common fleet; and
a consistency check module configured to detect an anomaly based on a fleet-based analysis of control data.

20. The system of claim 13, wherein each intelligent network sensor of the plurality of intelligent network sensors is a network-based plant floor sensor and the first automation device and the second automation device are plant floor automation devices.
